(19) United States
(12) Patent Application Publication
(10) Pub. No.: US 2024/0260751 A1
(43) Pub. Date: Aug. 8, 2024

(54) Roller Systems for Moving and Supporting Loads on Tracks

(71) Applicant: Harsoyo Lukito, Orange, CA (US)

(72) Inventor: Harsoyo Lukito, Orange, CA (US)

(21) Appl. No.: 18/107,412

(22) Filed: Feb. 8, 2023

(51) Int. Cl. A47B 88/437; A47B 88/487; B60R 11/06; E05D 15/06

(52) U.S. Cl. CPC A47B 88/437; A47B 88/487; B60R 11/06; E05D 15/0643; E05D 15/0652

(57) ABSTRACT

A system has a weight having a base that has at least one pair of rollers provided at the rear end of the base, and a track having a wheel or rollers provided adjacent the front end of the track. The base travels along the track between a first position where the at least one pair of rollers is at the rear end of the track, and a second position where the at least one pair of rollers is adjacent the wheel or rollers of the track, with the track functioning as a stop element to limit the frontward motion of the at least one pair of rollers.

### BACKGROUND OF THE INVENTION

### 1. Field of the Invention

The present invention relates to roller systems that are used for moving (or transporting) and supporting loads or weights along a track system.

### 2. Description of the Prior Art

There are applications where a weight or load (hereinafter “weight”) is carried for movement along a predetermined track between two positions.

For example, referring to FIG. 12, a pickup truck can have one or more drawers supported for movement on a track or a track system that is mounted to the bed of the truck. The drawers can be normally stowed inside the bed of the truck, and then the drawers can be pulled out from the truck bed for access to the contents inside the drawers.

As another example, referring to FIG. 21A, a gate can be supported for movement along a track that is built into the ground or other surface. The gate can be withdrawn along the track to open an entry-way or door or opening, and can then be moved along the track to a locked or closed position.

In both applications, rollers typically are provided under the weight (e.g., drawers or gate) that travel along a track mounted to the ground or surface (e.g., truck bed). In an application or environment where the underlying track can extend to the desired maximum length of the travel of the weight (see FIGS. 1A and 1B), the weight W can also travel 100% of that desired length.

However, there is a limit to which the underlying track can extend in some applications. For example, for the truck bed of FIG. 12, there is no track that will support the portions of the drawer that are withdrawn off the truck bed.

Thus, there remains a need for systems that can effectively allow a weight to travel from a track to an area with no underlying track, and in particular, that can effectively extend the length of the travel for the weight.

### SUMMARY OF THE DISCLOSURE

It is an object of the present invention to provide a system that can effectively allow a weight to travel from a track to an area with no underlying track.

It is another object of the present invention to provide a system that can effectively extend the length of the travel for the weight along an area with no underlying track

In order to accomplish the objects of the present invention, there is provided a system that has a weight having a base that has at least one pair of rollers provided at the rear end of the base, and a track having a wheel or rollers provided adjacent the front end of the track. The base travels along the track between a first position where the at least one pair of rollers is at the rear end of the track, and a second position where the at least one pair of rollers is adjacent the wheel or rollers of the track, with the track functioning as a stop element to limit the frontward motion of the at least one pair of rollers.

According to one embodiment, a pivoting extension track is provided to the track, and a support is provided on the bottom of the pivoting extension track so that the support can rest on a ground or surface and allow the pivoting extension track to be a continuation or extension of the track to facilitate travel by the base to a new end that is defined and supported by the pivoting extension track.

According to another embodiment, a ground support roller assembly is attached to the front of the weight or the base so that the ground support roller assembly can provide height support from the ground when the weight travels along an uneven surface.

In some embodiments, the weight can be a drawer on the bed of a truck, or a rolling gate. The track can be secured to the bed of a truck or the ground, and the pivoting extension track can be secured to the tailgate of a truck.

### BRIEF DESCRIPTION OF THE DRAWINGS

FIG. 1A is a side view illustrating a weight in a stowed position along a track.

FIG. 1B is a side view illustrating the weight of FIG. 1A in a fully deployed position along a track.

FIG. 2A is a side view illustrating a weight in a stowed position along a track system.

FIG. 2B is a side view illustrating the weight of FIG. 2A in a fully deployed position along the track system of FIG. 2A.

FIG. 3A is a side view illustrating a weight in a stowed position along a track system.

FIG. 3B is a side view illustrating the weight of FIG. 3A in a fully deployed position along the track system of FIG. 3A.

FIG. 4A is a side view illustrating a weight in a stowed position along a track system.

FIG. 4B is a side view illustrating the weight of FIG. 4A in a fully deployed position along the track system of FIG. 4A.

FIG. 5 is an exploded perspective view of a base and roller system that can be used to implement the concepts of FIGS. 1A-1B.

FIG. 6 is a cross-sectional front view of the base and roller system of FIG. 5.

FIG. 7 is a bottom perspective view of the base and roller system of FIG. 5.

FIG. 8A is an exploded perspective view of a drawer system for use on a truck bed.

FIG. 8B is an enlarged exploded perspective view of the circled region shown in FIG. 8A.

FIG. 9A is another exploded perspective view of the drawer system of FIG. 8A.

FIG. 9B is an enlarged exploded perspective view of the circled region 9-1 shown at the front of FIG. 9A.

FIG. 9C is an enlarged exploded perspective view of the circled region 9-2 shown at the rear of FIG. 9A.

FIG. 10A is cross-sectional side view of the drawer system of FIG. 8A shown with the drawer in the stowed position.

FIG. 10B is an enlarged side view of the circled region 10-1 shown at the front of FIG. 10A.

FIG. 10C is an enlarged side view of the circled region 10-2 shown at the rear of FIG. 10A.

FIG. 11A is cross-sectional side view of the drawer system of FIG. 8A shown with the drawer in the opened position.

FIG. 11B is an enlarged side view of the circled region shown in FIG. 11A.

FIG. 12 shows a truck having a truck bed having a drawer system secured to the truck bed.

FIG. 13A is a side view of FIG. 12 showing the drawers in a stowed position inside the housing.

FIG. 13B is an enlarged side view of the circled region shown in FIG. 13A.

FIG. 14A is a side views of FIG. 12 showing a drawer pulled out and supported by the extension on the tailgate.

FIG. 14B is an enlarged side view of the circled region shown in FIG. 14A.

FIG. 15A is an exploded perspective view of another drawer system for use on a truck bed.

FIG. 15B is an enlarged exploded perspective view of the circled region 15-1 shown in FIG. 15A.

FIG. 15C is an enlarged exploded perspective view of the circled region 15-2 shown in FIG. 15A.

FIG. 16A is another exploded perspective view of the drawer system of FIG. 15A.

FIG. 16B is an enlarged exploded perspective view of the circled region 16-1 shown at the front of FIG. 16A.

FIG. 16C is an enlarged exploded perspective view of the circled region 16-2 shown at the rear of FIG. 16A.

FIG. 17A is a cross-sectional side view of the drawer system of FIG. 15A shown with the drawer in the stowed position, and the truck tailgate in the lifted position.

FIG. 17B is an enlarged side view of the circled region shown at the rear of FIG. 17A.

FIG. 18A is another cross-sectional side view of the drawer system of FIG. 15A shown with the drawer in the stowed position.

FIG. 18B is an enlarged side view of the circled region shown at the front of FIG. 18A.

FIG. 19A is a cross-sectional side view of the drawer system of FIG. 15A shown with the drawer in the opened position.

FIG. 19B is an enlarged side view of the circled region 19-1 shown in FIG. 19A.

FIG. 19C is an enlarged side view of the circled region 19-2 shown in FIG. 19A.

FIG. 20 is a perspective view of the drawer system of FIG. 15A shown with the drawers in the opened position.

FIG. 21A is an exploded perspective view of a gate system which adopts the principles of FIGS. 4A and 4B.

FIG. 21B is an enlarged exploded perspective view of the circled region 21-1 shown at the front of FIG. 21A.

FIG. 21C is an enlarged exploded perspective view of the circled region 22-2 shown at the rear of FIG. 21A.

FIG. 22A is a side view of the gate system of FIG. 21A shown with the gate in the withdrawn or opened position.

FIG. 22B is an enlarged view of the circled region shown in FIG. 22A.

FIG. 23 is a cross-sectional view taken along line G-G of FIG. 22B.

FIG. 24A is a perspective view of the gate system of FIG. 21A shown with the gate in the withdrawn or opened position.

FIG. 24B is an enlarged perspective view of the circled region shown in FIG. 24A.

FIG. 25A is a perspective view of the gate system of FIG. 21A shown with the gate in the extended or partially closed position.

FIG. 25B is an enlarged perspective view of the circled region shown in FIG. 25A.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

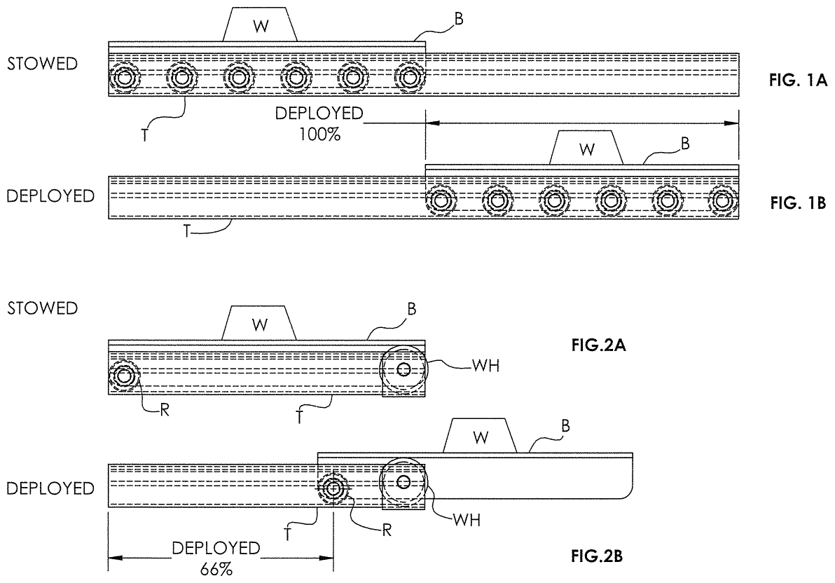

FIGS. 1A-4B illustrate the general principles of the present invention. Referring first to FIGS. 1A and 1B, a weight W is carried on a base B that has a plurality of rollers provided underneath the base B. The base B travels along a track T that defines the limits of travel for the base B. FIG. 1A shows the base B in a stowed position at one end of the track T, while FIG. 1B shows the base B in a fully deployed position at the other end of the track T. In this example, the base B is supported by the track T along the entirety of the intended travel distance for the base B.

In some applications, it is either undesirable or difficult to provide a track that supports a portion of the travel that a base B needs to traverse. FIGS. 2A and 2B illustrate a track T that has approximately the same length as the length of the base B, but where the base B needs to travel beyond one end of the track T. In order to prevent the base B from becoming disengaged from the track T, only a percentage of the base B can be extended beyond the end of the track T, thereby leaving a smaller percentage of the base B on the track T. This is particularly true in the case where the track T is located above the ground, such as where the track T is on the bed of a truck, so that the portion of the base B that extends beyond the end of the track T will be suspended in the air. For example, when a drawer is pulled out of the truck bed, the track T on the truck bed cannot extend outside the periphery of the truck bed, so that the withdrawn portion of the drawer is unsupported at the bottom. As shown in FIGS. 2A and 2B, the entire weight W (drawer) cannot be withdrawn from the truck bed, since a certain length of the weight W needs to remain on the track on the truck bed to provide the appropriate balance. In this case only about 66% of the length of the drawer can be safely withdrawn.

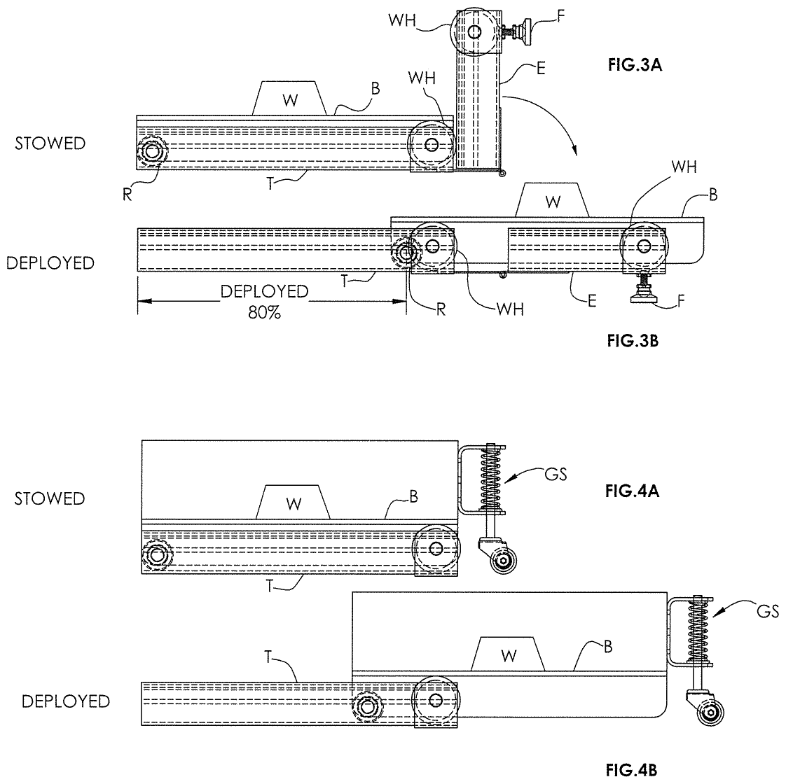

FIGS. 3A and 3B illustrate an application that is related to FIGS. 2A and 2B, where a pivoting extension E is provided to the track T, and a support F (e.g., an adjustable foot) is provided on the bottom of the extension E so that the support F can rest on the ground or truck tailgate and allow the extension E to be a continuation or extension of the track T to facilitate travel by the base B to a new end that is defined and supported by the extension E. For example, the extension E can be provided on the tailgate of a truck so that the tailgate can be used to help extend the length of the track T.

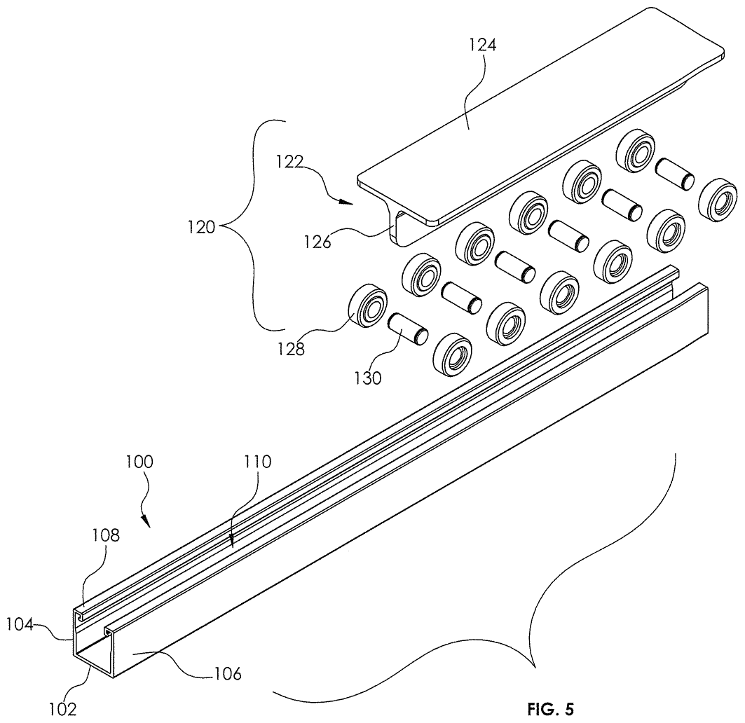

FIGS. 4A and 4B illustrate an application that extends the concepts illustrated in FIGS. 2A and 2B and FIGS. 3A and 3B. A ground support roller assembly GS is attached to the front of the weight W or the base B so that the ground support roller assembly GS can provide the same height support from the ground as the support F in FIGS. 3A and 3B, as the weight W travels along an uneven surface. For example, FIGS. 4A and 4B can be used for applications where the weight W is a gate. The ground support roller assembly GS can include a spring that allows the ground support roller assembly GS to adjust its travel to varying bumps and heights on an uneven surface.

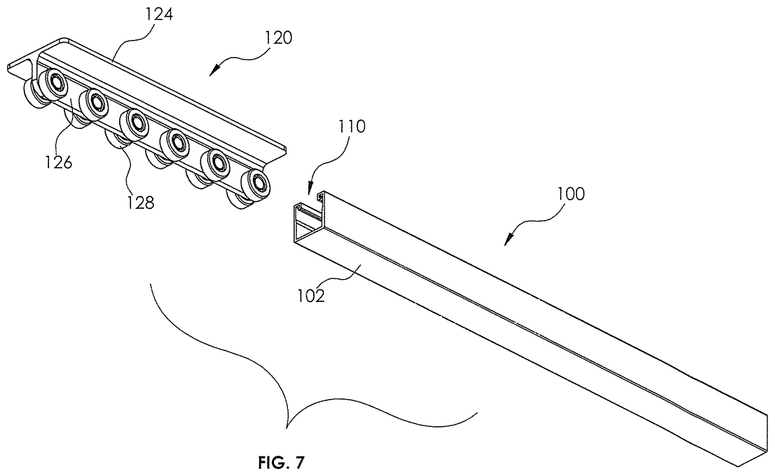

FIGS. 5-7 illustrate an embodiment that can be used to implement the concepts of FIGS. 1A-1B. In FIG. 5, the track T is defined by a horizontal chord 100 and the base B is defined by a base system 120.

The chord 100 can be configured as any conventional horizontal chord, or can be embodied using any of the strut configurations shown and described in U.S. Pat. No. 10,526,786, whose disclosure is incorporated by this reference as though set forth in full herein. For example, the horizontal chord 100 can be similar to the channel shown in FIG. 4A of U.S. Pat. No. 10,526,786, which has a back inner surface 102, two side inner surfaces 104 and 106, and two flanges 108 at the front of the channel. The surfaces of the channel are substantially planar and extend the length of the chord 100 which the channel is defined by. The side inner surfaces 104, 106 extend from and are substantially perpendicular to the back inner surface 102, and further are substantially parallel to each other. The side inner surfaces 104, 106 and the back inner surface 102 define three sides of the channel, wherein the fourth side completing the rectangle is referred to as the front of the channel. An opening 110 to the channel is defined by the space between the opposing flanges 108.

The base system 120 has a T-shaped base support 122 that has a horizontal panel 124 and a vertical wall 126 extending from about the bottom center of the panel 124. A weight W (not shown) is adapted to be supported (either secured to or removable from) the top surface of the panel 124. A plurality of pairs of rollers 128 are connected on either side of the wall 126 via shafts 130. The pairs of rollers 128 are spaced apart along the wall 126 and the number of pairs of rollers 128 can be varied depending on the application and use.

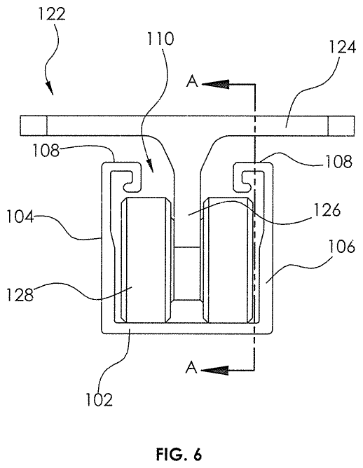

As best shown in FIG. 6, the pairs of rollers 128 are adapted to reside inside, and travel along, the channel that is defined by the surfaces 102, 104, 106 and the flanges 108. The wall 126 extends through the opening 110. As shown in FIGS. 1A, 1B, 5 and 7, the base system 120 can travel along the entire length of the track T (chord 100), where the length is usually at least twice the length of the base support 122.

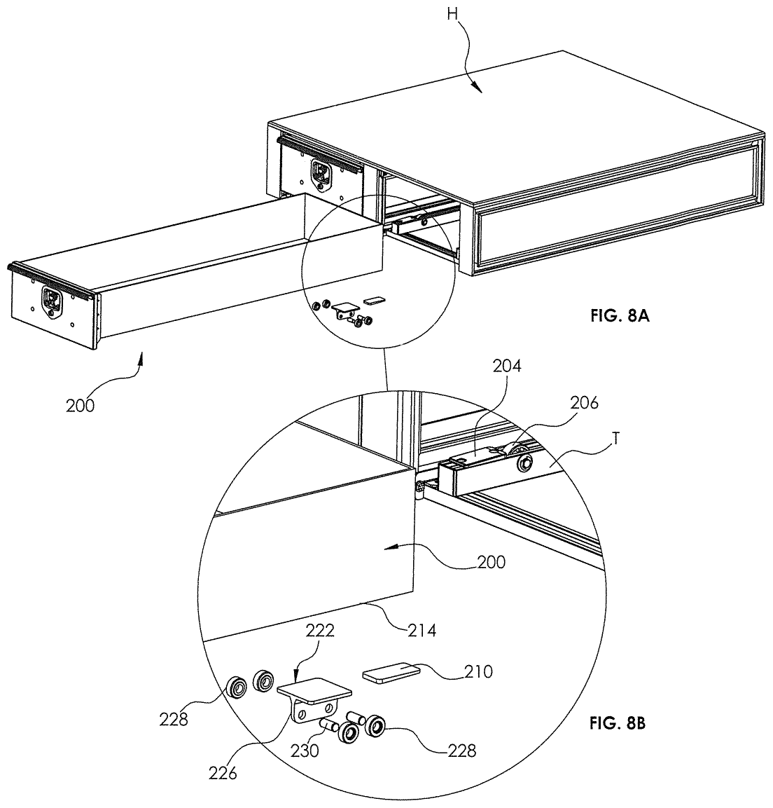

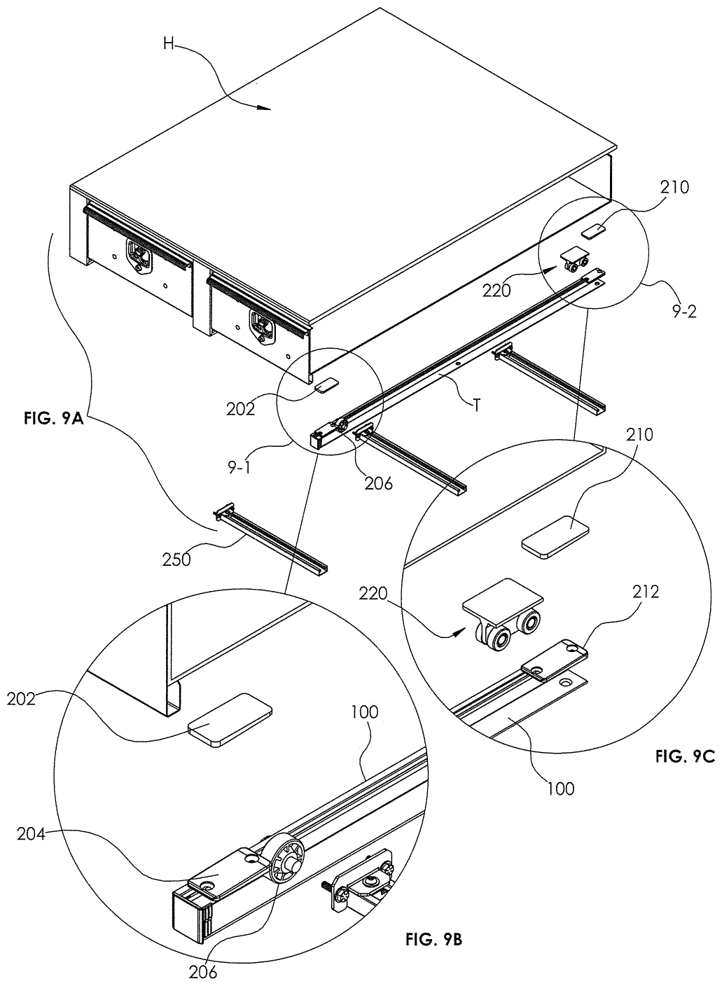

FIGS. 8A-11B illustrate an embodiment of a drawer system that can be used to implement the concepts of FIGS. 2A-2B. FIGS. 8A-11B illustrate a housing H that can be secured to the bed of a truck. A set of (i.e., a plurality of) tracks T are secured to connecting bars 250 that are positioned inside the housing H. The weight W can be embodied in the form of a drawer 200 that can be adapted to be housed inside the housing H and to travel along the track T to be withdrawn for access to its internal contents. In the embodiment shown in FIGS. 8A and 9A, there are two drawers 200 that are adapted to be positioned inside the housing H. The housing H can be secured to a truck bed in a manner similar to that shown in FIG. 12.

Each drawer 200 is adapted to be supported by two or more tracks T, with one track T provided along the bottom of each longitudinal side edge of the drawer 200. Each track T can be embodied in the form of the horizontal chord 100 described above in connection with FIGS. 5-7. A front top lifter 202 is secured to the bottom of each drawer 200 at each front corner thereof, and each front top lifter 202 is adapted to engage with a corresponding front bottom lifter 204 that is provided at the front end of each chord 100. Specifically, the front bottom lifter 204 is secured to the top of the opposing flanges 108 at the front end, and a front support wheel 206 is secured to the channel of the chord 100 for rotation immediately adjacent the front top lifter 202.

In addition, a rear top lifter 210 is secured to the bottom of each drawer 200 at each rear corner thereof, and each rear top lifter 210 is adapted to engage with a corresponding rear bottom lifter 212 that is provided at the rear end of each chord 100. Specifically, the rear bottom lifter 212 is secured to the top of the opposing flanges 108 at the rear end, and a base system 220 is secured to the bottom of the drawer 200 immediately adjacent the rear top lifter 210. Each base system 220 can be the same as the base system 120 described above, and in this embodiment, can have two pairs of rollers 228 supported by shafts 230 extending through the wall 226 of a T-shaped base support 222.

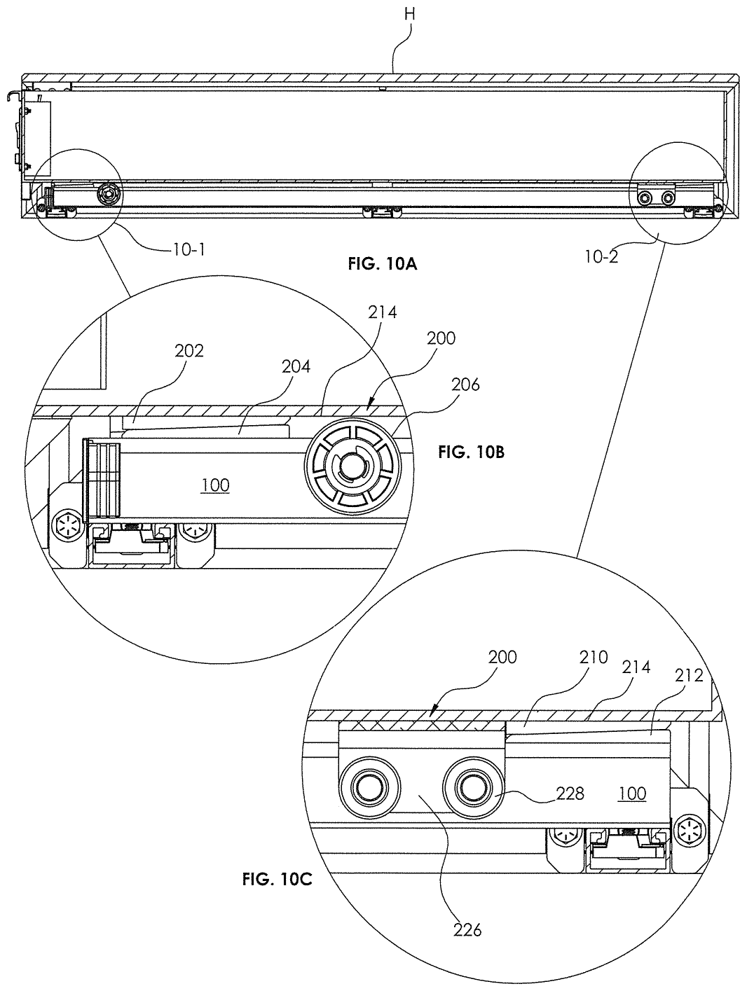

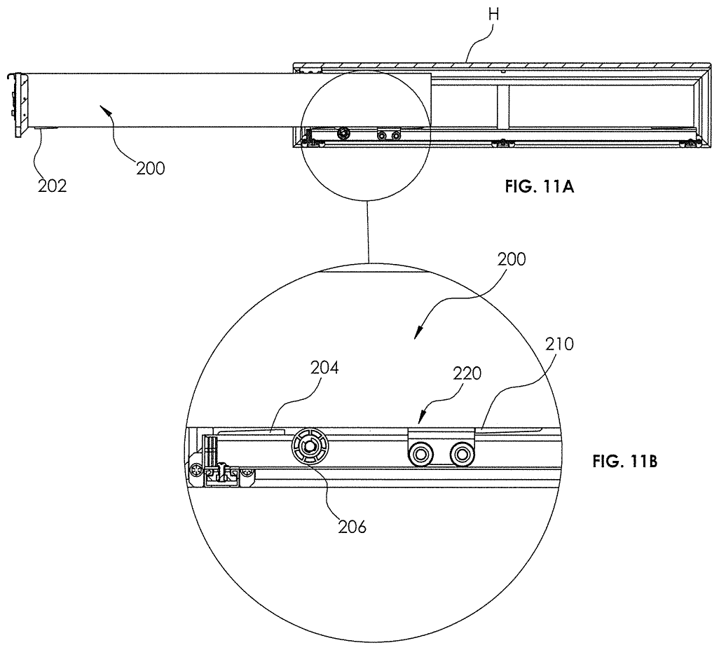

FIGS. 10A-10C illustrate the drawer 200 when it is stowed inside the housing H. FIGS. 10A-10C also illustrate how the pairs of lifters 202+204 and 210+212 operate to lift up the drawer 200 in the stowed position so that the rollers 228 are raised and therefore do not contact the back inner surface 102 of the chord 100, and so that the front support wheel 206 is separated from the bottom of the drawer 200 so that the front support wheel 206 does not contact the bottom wall 214 of the drawer 200. Specifically, each lifter 202, 204, 210 and 212 has a tapered cross-section so that its thickness varies progressively from a smallest thickness at one end to a largest thickness at an opposite end, so that each lifter 202, 204, 210 and 212 is essentially configured like a ramped surface. By positioning opposing top and bottom lifters so that the bases of their ramped surfaces are adapted to engage, the opposing top and bottom lifters can travel along their corresponding ramped surfaces to raise the drawer 200 from the track T.

It is desirable for the rollers 228 to be raised and not contact the back inner surface 102 of the chord 100, and for the front support wheel 206 to be separated from the bottom of the drawer 200 so that the front support wheel 206 does not contact the bottom of the drawer 200. The main idea of raising the front support wheel 206 and the rollers 228 is to relieve the load and impact pressure on the wheel/rollers whenever the truck is hitting a pot hole or dump during travel. Without the raising or lifting function, the wheel/rollers will fail prematurely if the road conditions are bad.

Finally, connecting bars 250, which can be the same structure as the chords 100, are provided to connect the two chords 100 of the two tracks T for each drawer 200.

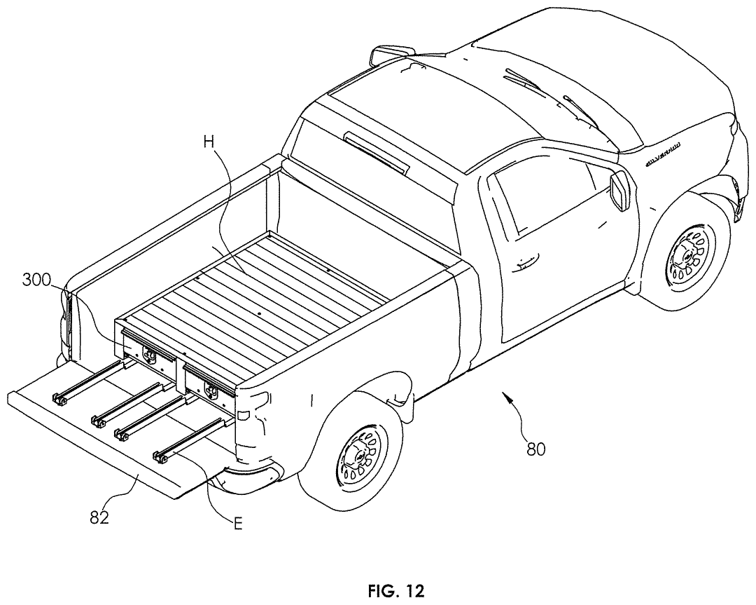

FIGS. 11A-11B illustrate the drawer 200 when it has been withdrawn from the housing H at its maximum extent into an opened position. As shown in FIG. 11B, the base system 220 approaches the front support wheel 206 and engages the front support wheel 206 which acts as a stop element to prevent the drawer 200 from being pulled out any further. As shown in FIG. 11A, about one-third of the drawer 200 is still housed inside the housing H, with about two-thirds of the drawer 200 pulled out. In this regard, FIG. 10A corresponds to the concept shown in FIG. 2A, and FIG. 11A corresponds to the concept shown in FIG. 2B, and where the rollers 228 correspond to the rollers R and the front support wheel 206 corresponds to the wheel WH in FIG. 2A and FIG. 2B.

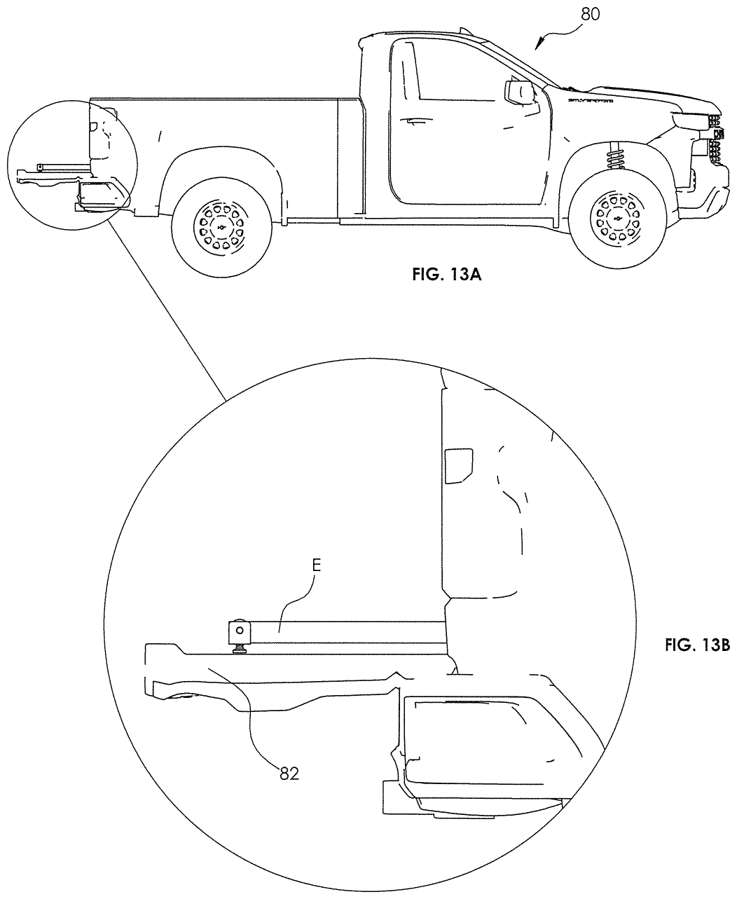

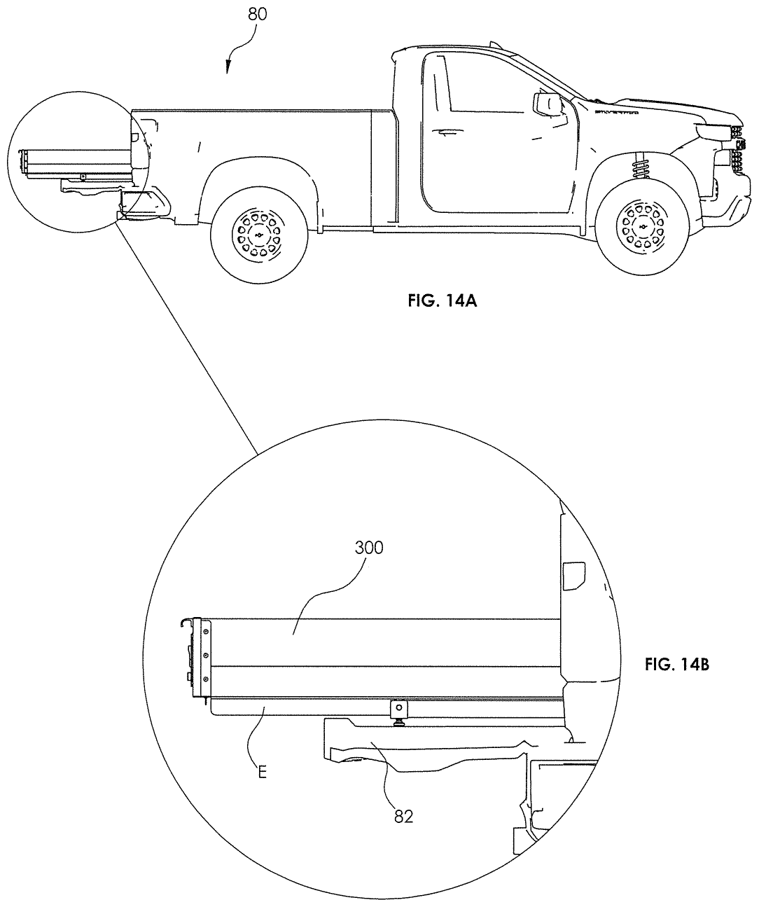

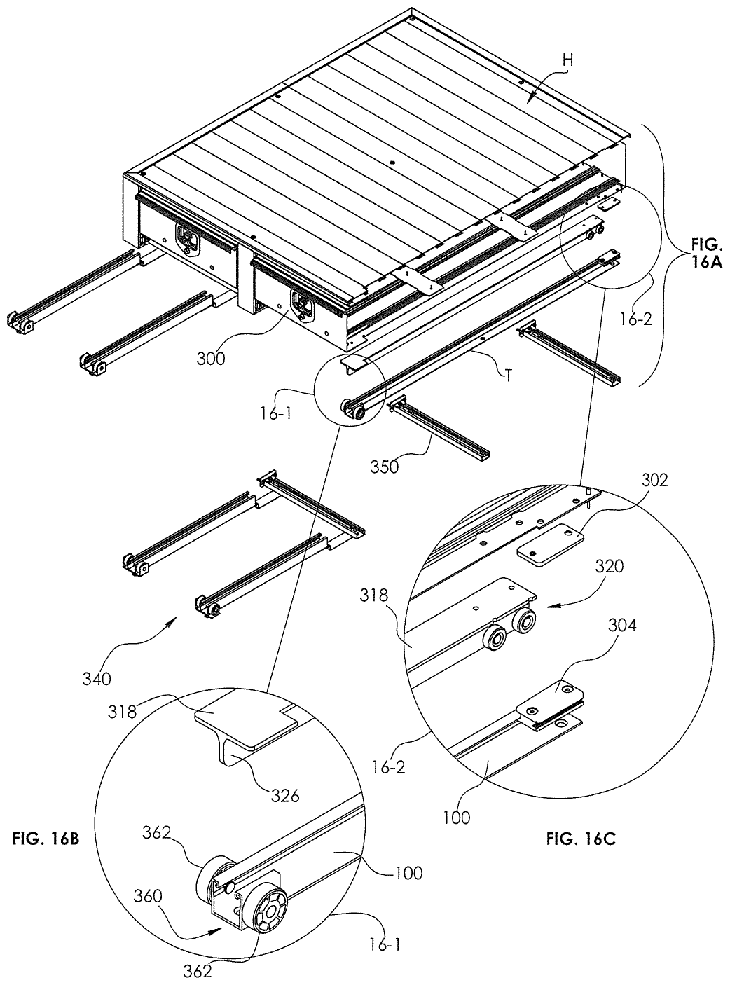

FIGS. 12-19C illustrate an embodiment that can be used to implement the concepts of FIGS. 3A-3B. FIG. 12 shows a truck 80 having a truck bed with two drawers 300 retained for sliding motion inside a housing H that is secured to the truck bed. In FIG. 12, the tailgate 82 is lowered and a plurality of pivoting extensions E (each of which corresponds to the pivoting extension E in FIGS. 3A and 3B) is secured to the upper surface of the tailgate 82. These pivoting extensions E are extensions to the tracks T that are secured to the drawer bed assembly. FIGS. 13A and 13B are side views of FIG. 12. FIGS. 14A and 14B are side views showing the drawer 300 pulled out and supported by the extension E on the tailgate 82.

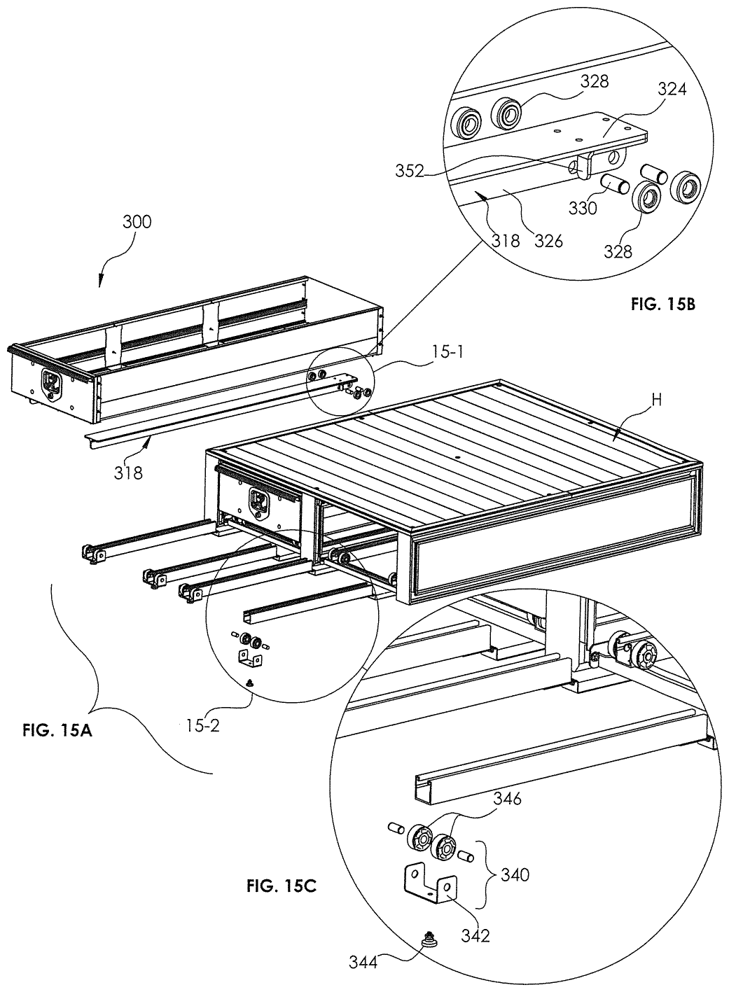

FIGS. 15A-19C illustrate in greater detail the system and components for implementing the concepts of FIGS. 3A-3B as embodied in FIGS. 12-14B. Each drawer 300 is adapted to be supported by two tracks T and two extensions E, with one track T provided along the bottom of each longitudinal side edge of the drawer 300. Each track T can be embodied in the form of the horizontal chord 100 described above in connection with FIGS. 5-7. A rear top lifter 302 is secured to the bottom of each drawer 300 at each rear corner thereof, and each rear top lifter 302 is adapted to engage with a corresponding rear bottom lifter 304 that is provided at the rear end of each chord 100. Specifically, the rear bottom lifter 304 is secured to the top of the opposing flanges 108 at the rear end, and an elongated T-bar 318 is secured to the bottom of the drawer 300 immediately adjacent the rear top lifter 302.

A base system 320 is provided at the rear end of the T-bar 318 and can be the same as the base system 120 described above, and in this embodiment. The base system 320 can have two pairs of rollers 328 supported by shafts 330 extending through the vertical wall 326 of the T-bar 318. The T-bar 318 extends from the rear top lifter 302 adjacent the rear end of the drawer 300 all the way to the front end of the drawer 300. The T-bar 318 has a horizontal bar or panel 324 and a vertical wall 326 extending from about the bottom center of the panel 324. The vertical wall 326 extends through the opening 110 and travels along the inside of the chord 100.

In addition, a stop bracket 352 is secured underneath the panel 324 at a location between the two rollers 328.

A first roller system 360 is provided at the front end of the chord 100 of the track T. The first roller system 360 essentially comprises a pair of opposing rollers or wheels 362 secured for rotation in the two side inner surfaces 104 and 106 of the chord 100.

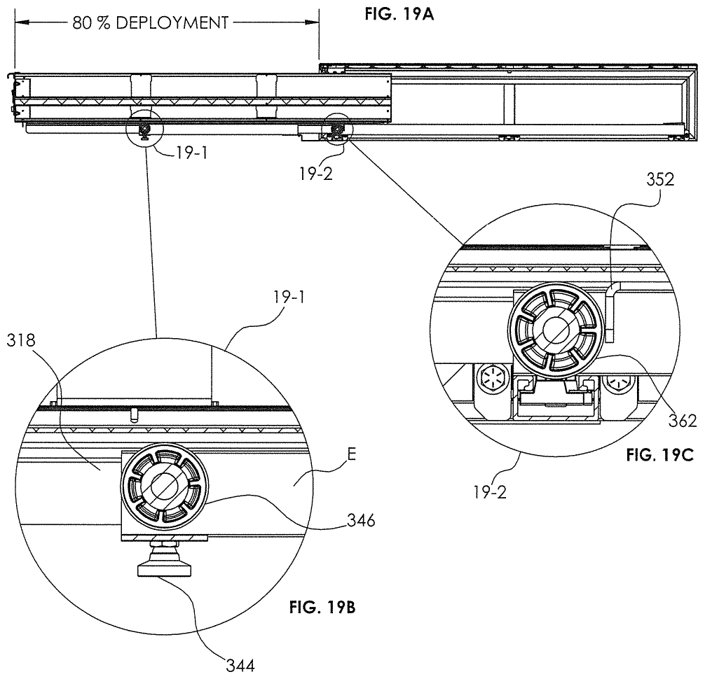

Each extension E is essentially another chord 100 that functions as an extension track so that when the tailgate 82 is lowered, the chord 100 of the extension E provides an extension to chord 100 of the track T that is secured to the truck bed. A second roller system 340 is provided at the front end of the extension E. The second roller system 340 has a U-bracket 342 that is adapted to be secured to the outer surfaces of the chord 100 at the front end by a pair of rollers or wheels 346. An adjustable screw 344 extends through openings in the bottom of the U-bracket 342 and the back inner surface 102 of the chord 100. The pair of rollers or wheels 346 are rotatably secured to the parallel walls of the U-bracket 342 and extend outside the chord 100 and the U-bracket 342. The screw 344 functions as an adjustable foot F that allows the user to adjust the height of the screw 344 so that the chord 100 of the extension E can be aligned to be on the same plane as the chord 100 of the track T (see FIGS. 19A and 19B).

Finally, connecting bars 350, which can be the same structure as the chords 100, are provided to connect the two chords 100 of the two tracks T for each drawer 300.

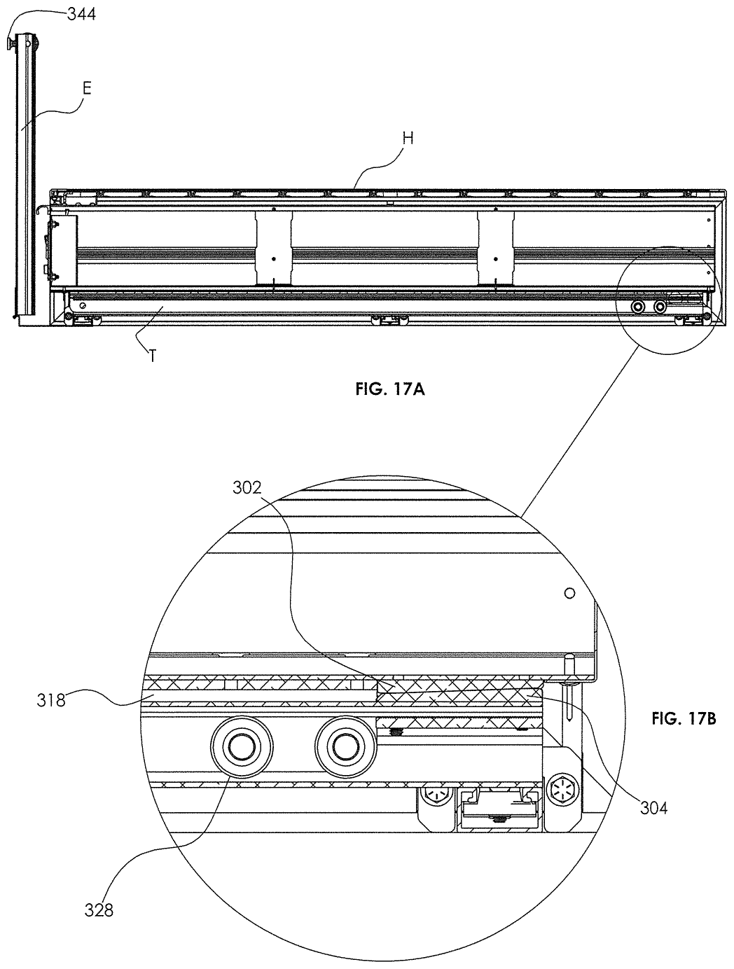

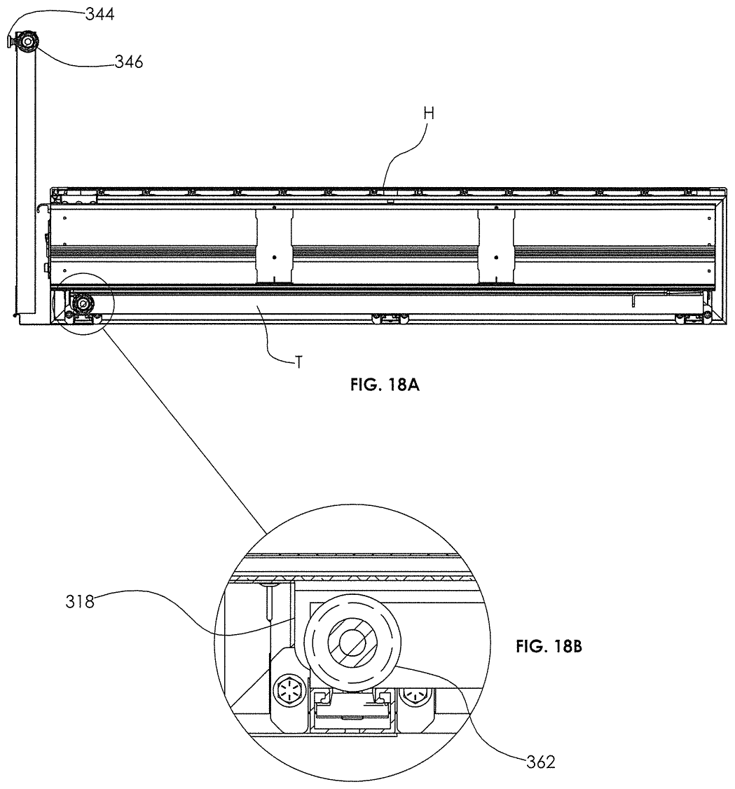

FIGS. 17A-18B illustrate the drawer 300 when it is stowed inside the housing H. FIGS. 17A-17B also illustrate how the pair of lifters 302 and 304 operate to lift up the drawer 300 in the stowed position so that the rollers 328 are raised and therefore do not contact the back inner surface 102 of the chord 100. When in the stowed position, the tailgate 82 is lifted up.

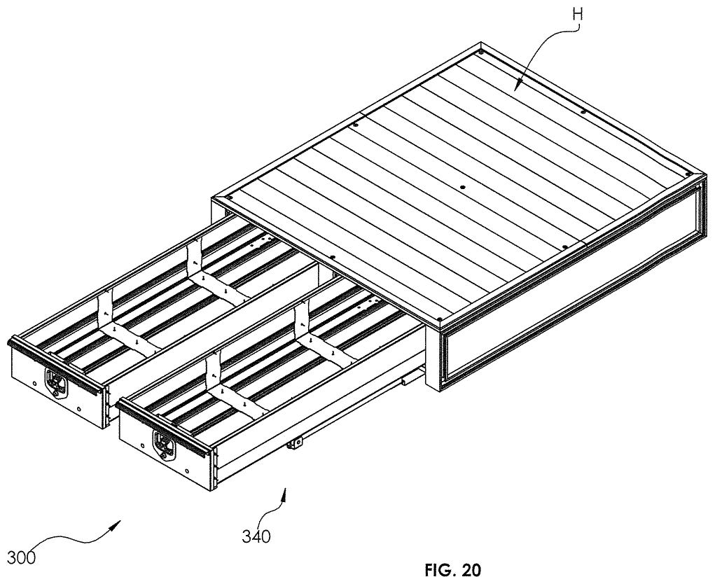

FIGS. 19A-19C and 20 illustrate the drawer 300 when it has been withdrawn from the housing H at its maximum extent into an opened position. In this position, the tailgate 82 is lowered and the chords 100 of the extensions E are aligned with the chords 100 of the tracks T. As shown in FIGS. 19A and 19B, the T-bar 318 can extend beyond the wheels 346 and the screw 344. The base system 320 approaches the wheel 362 and the stop bracket 352 engages the wheel 362 to prevent the drawer 300 from being pulled out any further. As shown in FIG. 19A, about 20% of the length of the drawer 300 is still housed inside the housing H, with about 80% of the length of the drawer 300 pulled out. In this regard, FIGS. 17A and 18A correspond to the concept shown in FIG. 3A, and FIG. 19A corresponds to the concept shown in FIG. 3B, and where the rollers 328 correspond to the rollers R and the wheels 362 and 346 correspond to the wheels WH in FIGS. 3A and 3B.

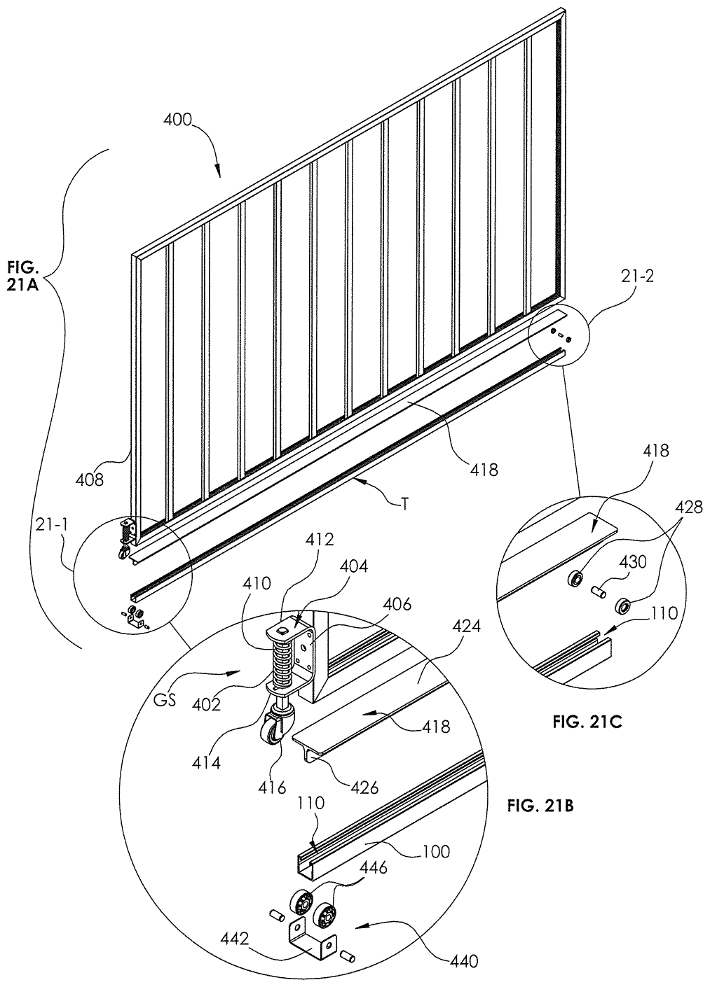

FIGS. 21A-25B illustrate in greater detail the system and components for implementing the concepts of FIGS. 4A-4B. A ground support roller assembly GS is attached to the front of a gate 400 (i.e., the weight W or the base B) so that the ground support roller GS can provide height support from the ground as the gate 400 is moved along the track T. More specifically, the ground support roller assembly GS can include a spring 402 that allows the ground support roller assembly GS to adjust its travel to varying bumps and heights on an uneven surface.

The ground support roller assembly GS has a C-shaped bracket 404 having a vertical surface 406 secured to a front vertical wall 408 of the gate 400. A shaft 410 extends between the two arms 412 and 414 of the bracket 404, and the spring 402 is wound around the shaft 410. The shaft 410 extends below the lower arm 414 and is connected thereto a caster wheel 416.

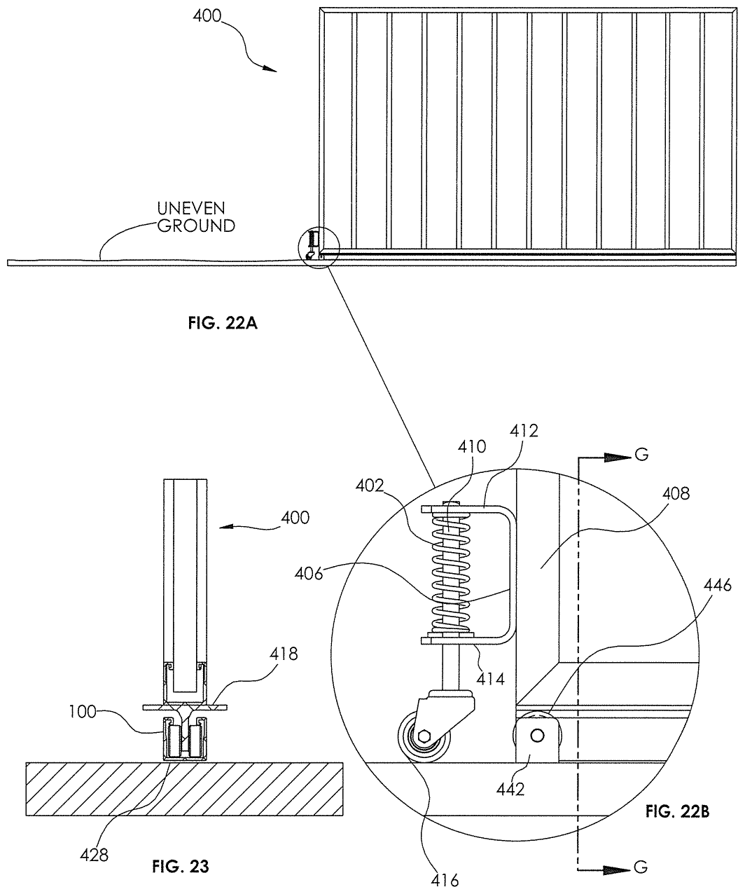

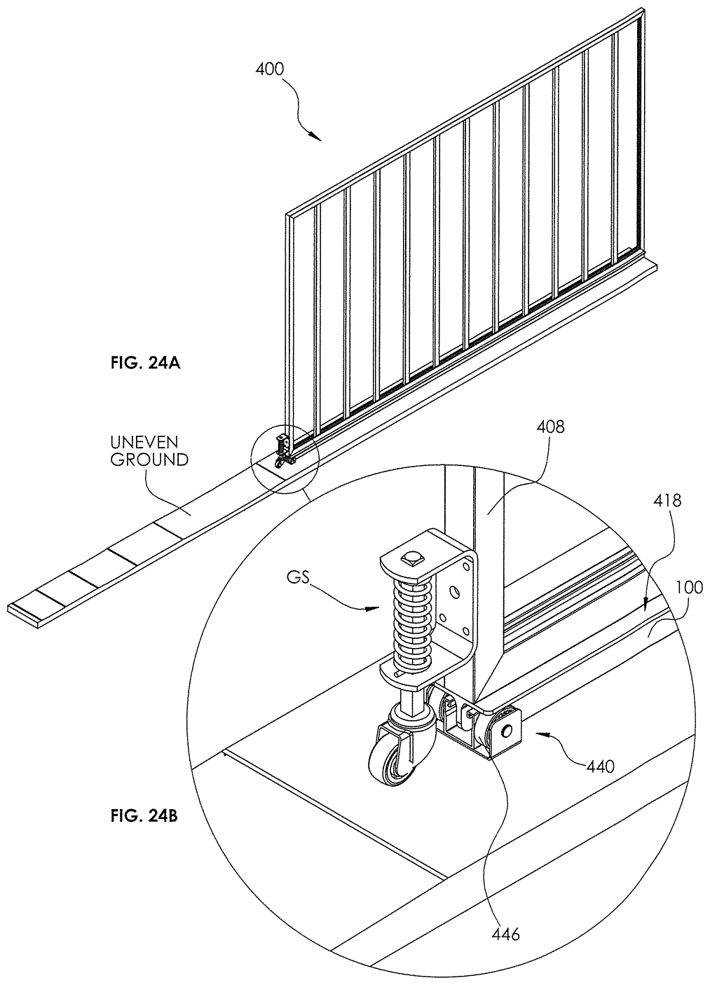

A T-bar 418 is secured below the bottom edge of the gate 400. The T-bar 418 can be the same as T-bar 318 described above. A pair of rollers 428 is supported by a shaft 430 extending through the vertical wall 426 of the T-bar 418. The T-bar 418 has a horizontal bar or panel 424 and a vertical wall 426 extending from about the bottom center of the panel 424. The vertical wall 426 extends through the opening 110 and travels along the inside of the chord 100 (see FIG. 23).

A roller system 440, which can be the same as the roller system 340 described above, is provided at the front end of chord 100 of the track T. The roller system 440 has a U-bracket 442 that is adapted to be secured to the outer surfaces of the chord 100 at the front end. A pair of rollers or wheels 446 are rotatably secured to the parallel walls of the U-bracket 442 and extend outside the chord 100 and the U-bracket 442.

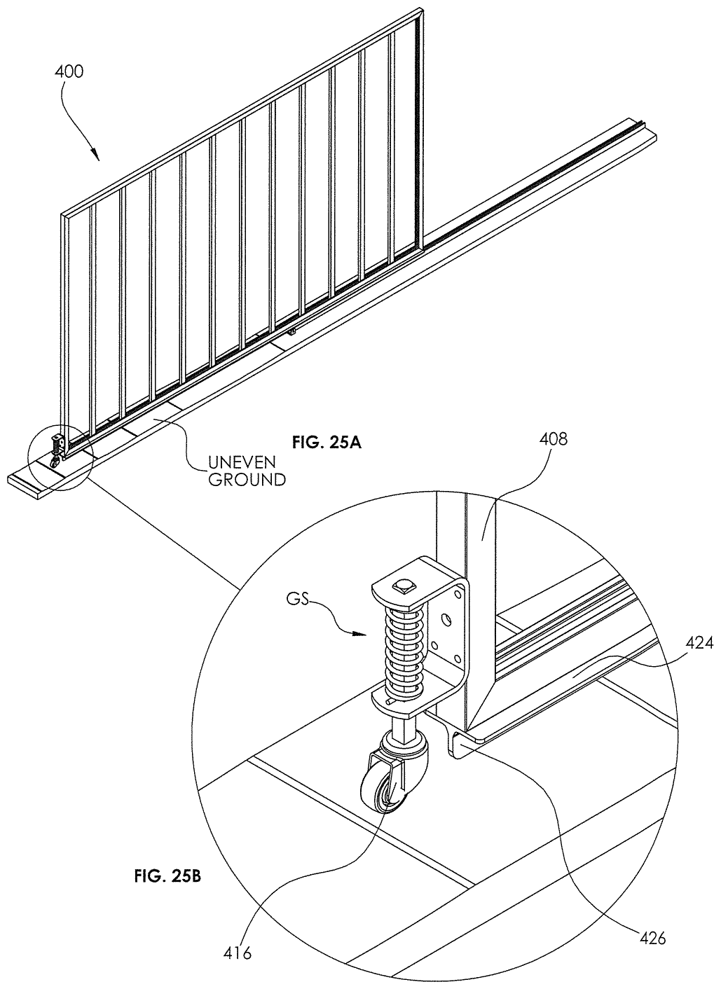

FIGS. 22A, 22B, 24A and 24B illustrate the gate 400 when it is in the withdrawn or opened position, where the ground roller support assembly GS is adjacent the front of the chord 100 and the roller system 440. FIGS. 25A and 25B illustrate the gate 400 when it is extended across an uneven ground surface to close or block an entrance. At its full extension, the rollers 428 will be adjacent to the wheels 446, similar to what is shown in FIG. 4B.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A system, comprising:
a weight having a base, the base having a front end and a rear end, and at least one pair of rollers provided at the rear end of the base;
a track having a front end and a rear end, the track having a wheel provided adjacent the front end of the track; and
wherein the base travels along the track between a first position where the at least one pair of rollers is at the rear end of the track, and a second position where the at least one pair of rollers is adjacent the wheel of the track, with the track functioning as a stop element to limit the frontward motion of the at least one pair of rollers.

2. The system of claim 1, wherein approximately two-thirds of the base extends beyond the front end of the track in the second position.

3. The system of claim 1, wherein the weight is a drawer and the track is secured to a truckbed.

4. The system of claim 1, wherein:
the base has a bottom, a front top lifter is secured to the bottom of the base adjacent the front end of the base, and a rear top lifter is secured to the bottom of the base adjacent the rear end of the base;
a front bottom lifter is secured to the front end of the track and a rear bottom lifter is secured to the rear end of the track;
wherein each lifter has a ramped surface; and
wherein the front bottom lifter lifts the front top lifter when they engage each other along their ramped surfaces, and the rear bottom lifter lifts the rear top lifter when they engage each other.

5. A system, comprising:
a weight having a base, the base having a front end and a rear end, and at least one pair of rollers provided at the rear end of the base;
a main track having a front end and a rear end, the main track having a wheel provided adjacent the front end of the main track;
a pivoting extension track that is secured to a pivoting support surface, the extension track having a rear end that is aligned with the front end of the main track and a front end that has a pair of rollers and an adjustable height support; and
wherein the base travels along the main track between a first position where the at least one pair of rollers is at the rear end of the main track, and a second position where the at least one pair of rollers is adjacent the wheel of the main track, and the base resting on the pair of rollers of the extension track; and
wherein the pivoting support surface is pivoted between a stowage position and a use position, with the extension track and the pivoting surface perpendicular with respect to the main track in the stowage position.

6. The system of claim 5, wherein the weight is a drawer, the main track is secured to a truckbed, and the pivoting support surface is a tailgate of a truck.

7. The system of claim 5, wherein:
the base has a bottom, and a rear top lifter is secured to the bottom of the base adjacent the rear end of the base;
a rear bottom lifter that is secured to the rear end of the track;
wherein each lifter has a ramped surface; and
wherein the rear bottom lifter lifts the rear top lifter when they engage each other.

8. The system of claim 5, wherein the base is an elongated T-bar having a horizontal panel and a vertical wall extending from a bottom of the panel, with the vertical wall sized and configured to travel along the main track and the extension track, and wherein the at least one pair of rollers of the base is secured to the vertical wall.

9. A system, comprising:
a weight having a front end and a base, the base having a front end and a rear end, and at least one pair of rollers provided at the rear end of the base;
a track having a front end and a rear end, the track having a pair of wheels provided adjacent the front end of the track;
a ground support roller assembly secured to the front end of the weight, the ground support roller assembly having a bracket secured to the weight, a caster wheel connected to the bracket, and a spring retained by the bracket and coupled to the caster wheel; and
wherein the base travels along the track between a first position where the at least one pair of rollers is at the rear end of the track, and a second position where the at least one pair of rollers is adjacent the pair of wheel of the track.

10. The system of claim 9, wherein the bracket has a vertical surface that is secured to the weight and two opposite arms, with a shaft extending between the two arms, and with spring wound around the shaft, wherein shaft is connected to the caster wheel.

11. The system of claim 9, wherein the weight is a gate, and the track is secured to the ground.

12. The system of claim 9, wherein the base is an elongated T-bar having a horizontal panel and a vertical wall extending from a bottom of the panel, with the vertical wall sized and configured to travel along the track, and wherein the at least one pair of rollers of the base is secured to the vertical wall.
